(19) United States
(12) Patent Application Publication
(10) Pub. No.: US 2017/0173803 A1
(43) Pub. Date: Jun. 22, 2017

(54) Occupational Therapy System

(71) Applicant: Daryl T. Gathing, South Holland, IL (US)

(72) Inventor: Daryl T. Gathing, South Holland, IL (US)

(21) Appl. No.: 14/973,885

(22) Filed: Dec. 18, 2015

(51) Int. Cl. B26B 13/20

(52) U.S. Cl. CPC B26B 13/20

(57) ABSTRACT

An occupational therapy system for facilitating a pair of scissors to perform occupational therapy includes a pair of scissors. A pair of grips is provided. Each of the grips is removably coupled to the scissors. Each of the grips enhances manipulation of the scissors.

### BACKGROUND OF THE DISCLOSURE

### Field of the Disclosure

The disclosure relates to therapy devices and more particularly pertains to a new therapy device for facilitating a pair of scissors to perform occupational therapy.

### SUMMARY OF THE DISCLOSURE

An embodiment of the disclosure meets the needs presented above by generally comprising a pair of scissors. A pair of grips is provided. Each of the grips is removably coupled to the scissors. Each of the grips enhances manipulation of the scissors.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of an occupational therapy system according to an embodiment of the disclosure.

FIG. 2 is a left side view of an embodiment of the disclosure.

FIG. 3 is a cross sectional view taken along line 3-3 of FIG. 2 of an embodiment of the disclosure.

FIG. 4 is a right side exploded view of an embodiment of the disclosure.

FIG. 5 is a bottom view of an embodiment of the disclosure.

FIG. 6 is a perspective view of an alternative embodiment of the disclosure.

FIG. 7 is a right side exploded view of an alternative embodiment of the disclosure.

FIG. 8 is a cross sectional view taken along line 8-8 of FIG. 6 of an embodiment of the disclosure.

### DESCRIPTION OF THE PREFERRED EMBODIMENT

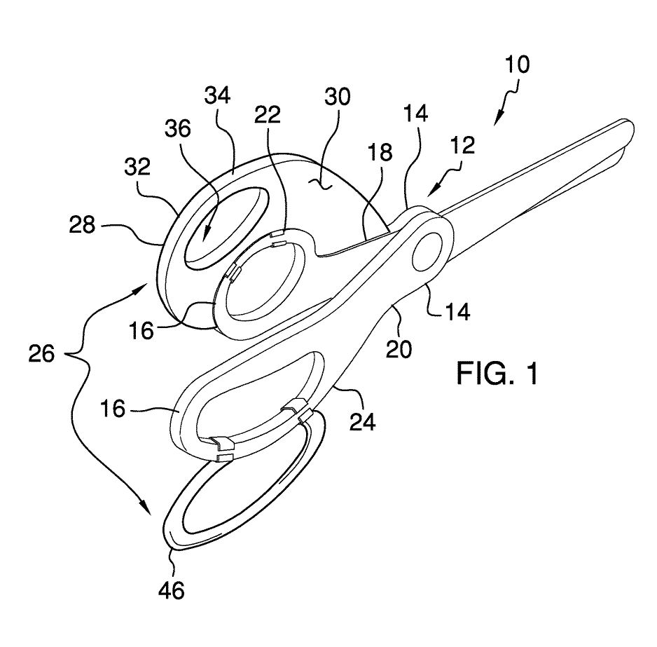

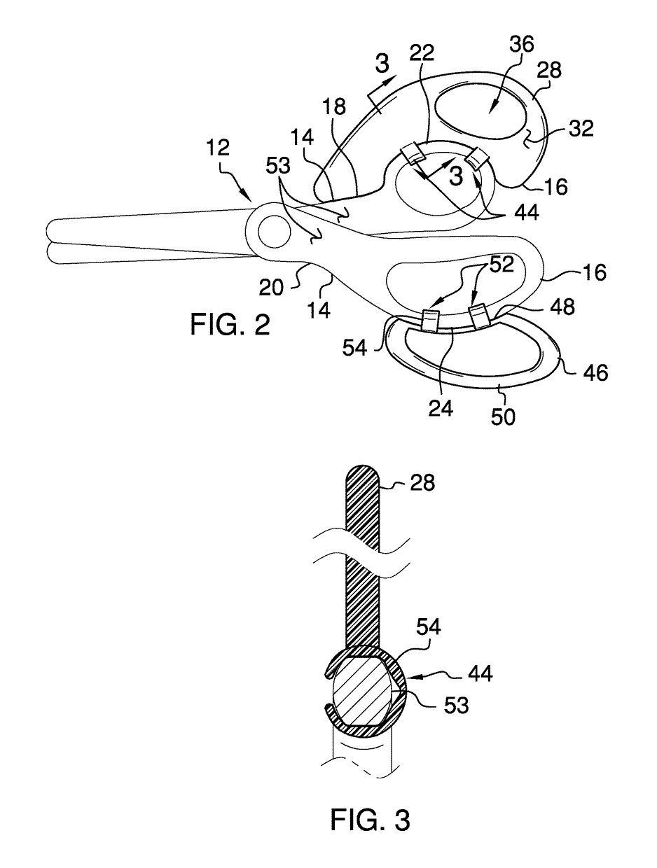

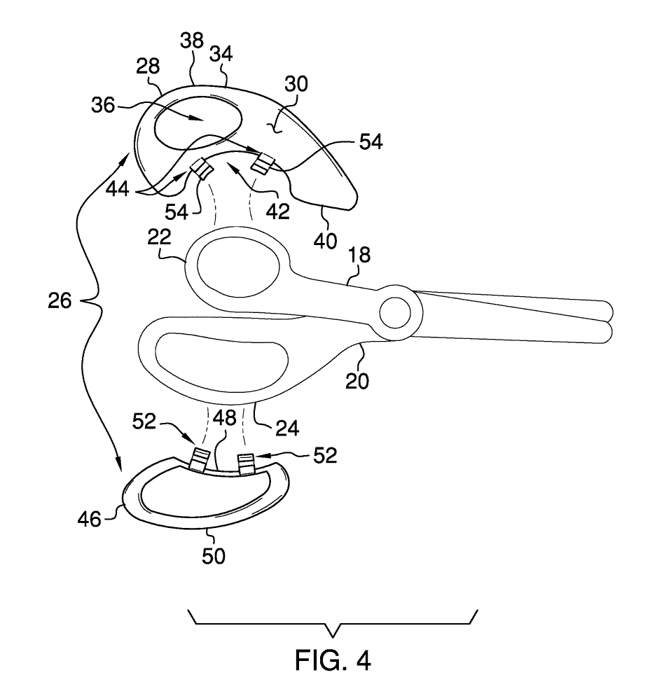

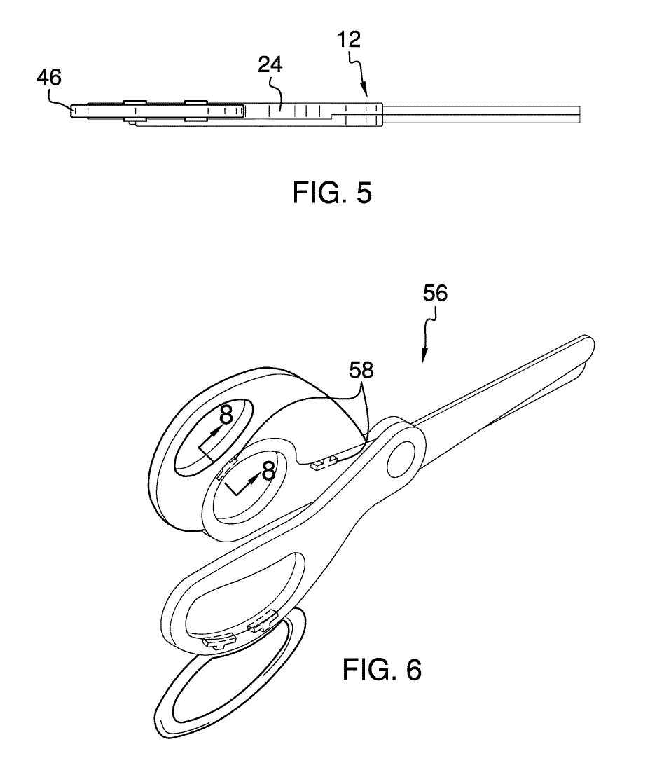

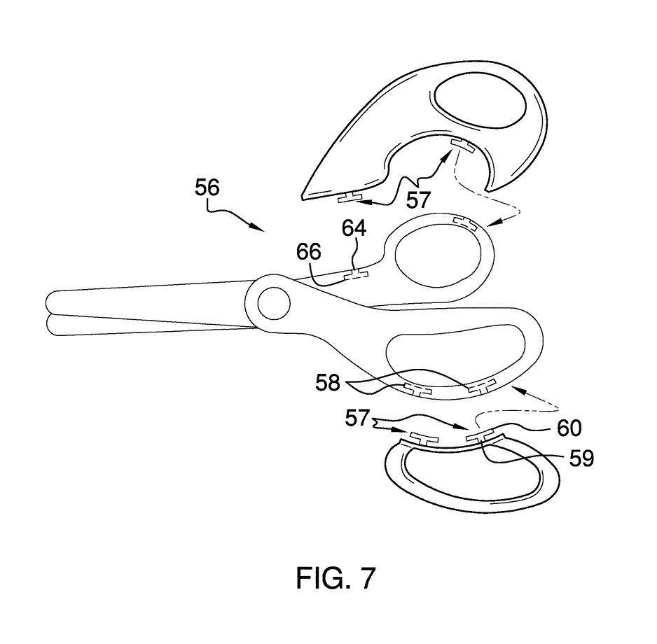

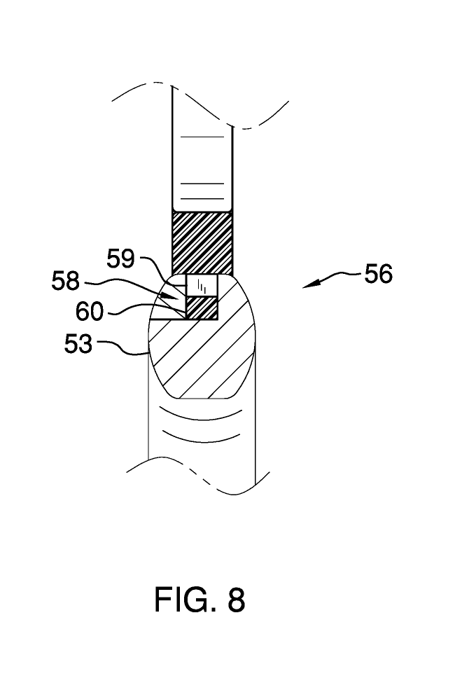

With reference now to the drawings, and in particular to FIGS. 1 through 8 thereof, a new therapy device embodying the principles and concepts of an embodiment of the disclosure and generally designated by the reference numeral 10 will be described.

As best illustrated in FIGS. 1 through 8, the occupational therapy system 10 generally comprises a pair of scissors 12 and each of the scissors 12 includes a handle 14. The handle 14 corresponding to each of the scissors 12 has a looped portion 16. The looped portion 16 corresponding to each of the handles 14 may have a digit extended therethrough thereby facilitating the scissors 12 to be manipulated. The digit may comprise a thumb and fingers. The pair of scissors 12 includes a thumb scissor 18 and a finger scissor 20. The thumb scissor 18 has an upper edge 22 and the finger scissor 20 has a lower edge 24.

A pair of grips 26 is provided. Each of the grips 26 is removably coupled to the scissors 12. Thus, each of the grips 26 enhances manipulation of the scissors 12 for a user. The user may be a physically disabled user, a developmentally disabled user or other user participating in occupational therapy.

The pair of grips 26 comprises a first grip 28 that is removably coupled to the thumb scissor 18. The first grip 28 enhances a grip of the thumb scissor 18. The first grip 28 has a first surface 30, a second surface 32 and a peripheral edge 34 extending between the first surface 30 and the second surface 32. The first grip 28 has an aperture 36 extending through the first surface 30 and the second surface 32. The aperture 36 may have a digit extended therethrough and the digit may be the thumb.

The peripheral edge 34 has a top side 38 and a bottom side 40. The aperture 36 is positioned closer to the top side 38 than the bottom side 40. The top side 38 is concavely arcuate with respect to the bottom side 40. The bottom side 40 has a bay 42 extending upwardly therein. The bottom side 40 abuts the upper edge 22 of the of the thumb scissor 18 having the looped portion 16 of the thumb scissor 18 positioned within the bay 42.

A pair of first couplers 44 is provided. Each of the first couplers 44 is coupled to the bottom side 40 of the first grip 28. Each of the couplers 44 removably engages the looped portion 16 corresponding to the thumb scissor 18. Thus, first grip 28 is removably retained on the thumb scissor 18.

A second grip 46 is removably coupled to the finger scissor 20 and the second grip 46 enhances a grip of the finger scissor 20. The second grip 46 is continuous such that the second grip 46 forms a closed loop. The second grip 46 has a first side 48 and a second side 50. The first side 48 is concavely arcuate with respect to the second side 50. The first side 48 abuts the lower edge 24 of the finger scissor 20.

A pair of second couplers 52 is provided. Each of the second couplers 52 is coupled to the first side 48. Each of the second couplers 52 removably engages the finger scissor 20. Thus, the second grip 46 is removably retained on the finger scissor 20. The handle 14 of each of the pair of scissors 12 has a first lateral surface 53. Each of the first pair of couplers 44 and the second pair of couplers 52 may comprise a clip 54. The clip 54 may insertably receive the first lateral surface 53 such that the clip 54 frictionally engages the scissors 12.

In alternative embodiment 56 as shown in FIGS. 6, 7 and 8 each of the pair of first couplers 44 and the pair of second couplers 52 may comprise a plurality of tabs 57 and a plurality of wells 58. Each of the tabs 57 includes a neck 59 and a base 60. The neck 58 is coupled to the associated bottom side 40 and the first side 48. The base 60 is oriented perpendicular to the neck 58.

The wells 58 associated with thumb scissor 18 extend inwardly from the first lateral surface 53 corresponding to the thumb scissor 18. The wells 58 associated with the finger scissor 20 extend inwardly from the first lateral surface 53 corresponding to the finger scissor 20. Each of the wells 58 has a first portion 64 that is oriented perpendicular to a second portion 66. The first portion 64 of each of the wells 58 interests an associated one of the upper edge 22 and the lower edge 24.

Each of the wells 58 corresponding to the thumb scissor 18 insertably receives an associated one of the tabs 57 corresponding to the first grip 28. Thus, the first grip 28 is removably retained on the thumb scissor 18. Each of the wells 58 corresponding to the finger scissor 20 insertably receives an associated one of the tabs 57 corresponding to the second grip 46. Thus, the second grip 46 is removably retained on the finger scissor 20.

In use, each of the first grip 28 and the second grip 46 are coupled the scissors 12 to facilitate the user to manipulate the scissors 12. The first grip 28 may be used independently of the second grip 46. The second grip 46 may be used independently of the first grip 28. The first grip 28 and the second grip 46 facilitate occupational therapy for the user. An assistant may assist the user to manipulate the first grip 28 and the second grip 46 when the first grip 28 and the second grip 46 are coupled to the scissors 12. The user may manipulate the first grip 28 and the second grip 46 without assistance when the user develops sufficient hand strength. The user may remove the first grip 28 and the second grip 46 from the scissors 12 when the user develops sufficient hand strength.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An occupational therapy system comprising:
a pair of scissors; and
a pair of grips, each of said grips being removably coupled to said scissors wherein each of said grips is configured to enhance manipulation of said scissors.

2. The system according to claim 1, wherein each of said scissors includes a handle, said handle corresponding to each of said scissors having a looped portion wherein said looped portion corresponding to each of said handles is configured to have a digit extended therethrough thereby facilitating said scissors to be manipulated, said pair of scissors comprising a thumb scissor and a finger scissor, said thumb scissor having an upper edge, said finger scissor having a lower edge.

3. The system according to claim 1, wherein:
said pair of scissors includes a thumb scissor; and
said pair of grips comprises a first grip being removably coupled to said thumb scissor wherein said first grip is configured to enhance a grip of said thumb scissor.

4. The system according to claim 3, wherein said first grip has a first surface, a second surface and a peripheral edge extending between said first surface and said second surface, said first grip having an aperture extending through said first surface and said second surface wherein said aperture is configured to have a digit extended therethrough.

5. The system according to claim 4, wherein:
each of said pair of scissors has a looped portion; and
said peripheral edge has a top side and a bottom side, said aperture being positioned closer to said top side than said bottom side, said top side being concavely arcuate with respect to said bottom side, said bottom side having a bay extending upwardly therein, said bottom side abutting said upper edge of said of said thumb scissor having said looped portion of said thumb scissor being positioned within said bay.

6. The system according to claim 5, further comprising a pair of first couplers, each of said first couplers being coupled to said bottom side of said first grip, each of said couplers removably engaging said looped portion corresponding to said thumb scissor such that first grip is removably retained on said thumb scissor.

7. The system according to claim 1, wherein:
said pair of scissors includes a finger scissor; and
said pair of grips includes a second grip being removably coupled to said finger scissor wherein said second grip is configured to enhance a grip of said finger scissor.

8. The system according to claim 7, wherein:
said finger scissor has a lower edge; and
said second grip being continuous such that said second grip forms a closed loop, said second grip having a first side and a second side, said first side being concavely arcuate with respect to said second side, said first side abutting said lower edge of said finger scissor.

9. The system according to claim 8, further comprising a pair of second couplers, each of said second couplers being coupled to said first side of said second grip, each of said second couplers removably engaging said finger scissor such that said second grip is removably retained on said finger scissor.

10. An occupational therapy system comprising:
a pair of scissors, each of said scissors including a handle, said handle corresponding to each of said scissors having a looped portion wherein said looped portion corresponding to each of said handles is configured to have a digit extended therethrough thereby facilitating said scissors to be manipulated, said pair of scissors comprising a thumb scissor and a finger scissor, said thumb scissor having an upper edge, said finger scissor having a lower edge; and
a pair of grips, each of said grips being removably coupled to said scissors wherein each of said grips is configured to enhance manipulation of said scissors, said pair of grips comprising:
a first grip being removably coupled to said thumb scissor wherein said first grip is configured to enhance a grip of said thumb scissor, said first grip having a first surface, a second surface and a peripheral edge extending between said first surface and said second surface, said first grip having an aperture extending through said first surface and said second surface wherein said aperture is configured to have a digit extended therethrough, said peripheral edge having a top side and a bottom side, said aperture being positioned closer to said top side than said bottom side, said top side being concavely arcuate with respect to said bottom side, said bottom side having a bay extending upwardly therein, said bottom side abutting said upper edge of said of said thumb scissor having said looped portion of said thumb scissor being positioned within said bay,
a pair of first couplers, each of said first couplers being coupled to said bottom side of said first grip, each of said couplers removably engaging said looped portion corresponding to said thumb scissor such that first grip is removably retained on said thumb scissor,
a second grip being removably coupled to said finger scissor wherein said second grip is configured to enhance a grip of said finger scissor, said second grip being continuous such that said second grip forms a closed loop, said second grip having a first side and a second side, said first side being concavely arcuate with respect to said second side, said first side abutting said lower edge of said finger scissor, and
a pair of second couplers, each of said second couplers being coupled to said first side of said second grip, each of said second couplers removably engaging said finger scissor such that said second grip is removably retained on said finger scissor.
